(19) United States
(12) Patent Application Publication
(10) Pub. No.: US 2013/0253978 A1
(43) Pub. Date: Sep. 26, 2013

(54) METHOD, APPARATUS AND PROGRAM FOR CALCULATING PROCUREMENT RISK

(71) Applicant: HITACHI, LTD., Tokyo (JP)

(72) Inventors: Tetsuro Adachi, Tokyo (JP); Kentaro Taguchi, Hiratsuka (JP); Satoshi Dempoya, Yokohama (JP)

(73) Assignee: HITACHI, LTD., Tokyo (JP)

(21) Appl. No.: 13/685,935

(22) Filed: Nov. 27, 2012

(30) Foreign Application Priority Data
Mar. 21, 2012 (JP) 2012-063022

(51) Int. Cl. G06Q 10/06

(52) U.S. Cl. CPC G06Q 10/0635
USPC 705/7.28

(57) ABSTRACT

A procurement risk calculation apparatus includes a control unit which accepts ordering information given by an orderer, via a network, and reads past ordering detail history information and BOM information, an operation unit which extracts a part for which plural corporation purchase is conducted and calculates a procurement risk such as a situation of dependence of child parts constituting an ordered part upon terminal suppliers on the basis of the ordering detail history information and the BOM information, and an output processing unit which outputs a screen to assist in determining selection intention of a part to be ordered and an order receiver enterprise on the basis of an operation result.

### INCORPORATION BY REFERENCE

The present application claims priority from Japanese application JP2012-063022 filed on Mar. 21, 2012, the content of which is hereby incorporated by reference into this application.

### BACKGROUND OF THE INVENTION

The present invention relates to a technique for an ordering enterprise to calculate and judge a procurement risk in a terminal supplier accurately and quickly when ordering a part.

In order for an enterprise (ordering enterprise) which manufactures or assembles products to be supplied with ordered parts stably, a conventional technique can accumulate, totalize and analyze information of past transactions with suppliers, and thereby present tendencies such as situations of observance of the delivery time, time periods of delivery, and inspection passing situations of ordered parts or suppliers to assist intention determination as to making a decision whether ordering can be conducted. According to JP-A-2008-159023, it is possible to assist selection of a part to be ordered by receiving the performance, durability, heat-resisting property, cost, delivery time, and creditability every part to be ordered and calculating and presenting the degree of recommendation of the part to be ordered.

### SUMMARY OF THE INVENTION

In business of ordering a part, it is necessary to select a supplier and a part to be ordered considering various situations, to ensure that the ordered part can be delivered surely according to the delivery time with a price within a target price and with demanded quality criteria satisfied. Situations to be considered are, for example, the production capability and stock situations of the supplier, the lead time and quality level caused by a design or manufacture method of the supplier, an interruption of a road/sea route network in the distribution process of products, a procedure time period in customs or the like, a sudden trouble in production facilities of the supplier, suffering of a manufacture line from a natural disaster, stopping of harbor works caused by a dispute, terrorism, or the like. A person in charge of ordering is required to consider such various supposed situations, grasp past transaction situations, conditions of location of the supplier, distribution path situations, weather, political situations, and the like, and select an optimum supplier and an optimum part to be ordered. The present invention relates to a technique for previously taking these situations into consideration, calculating risks in procurement accurately and quickly, and assisting procurement intention determination.

The person in charge of ordering selects a part and a supplier by a personal decision relying upon the situations of inspection and acceptance and the delivery time observance rate on the basis of various kinds of information such as information of past actual results of ordering, transaction experience, or characteristics of ordered parts. Therefore, there is a possibility that variations are caused in decision results depending upon knowledge of the orderer concerning the ordered part and experience of transactions with each supplier conducted until then. There is a problem of a delay of the ordered part from the delivery time and a problem that procurement of a part satisfying the quality criterion cannot be always ensured because of such a difference in intension determination result of order contents depending upon the person in charge of ordering.

As a conventional technique for solving this problem, there is a method of evaluating a part by accumulating past transaction information and past information, and referring to the accumulated information when ordering the part, a product, or a similar part. According to JP-A-2008-159023, it is possible to accumulate transaction information of performance, durability, heat-resisting property, cost, delivery time, and creditability every part or product transacted in the past, calculate the degree of recommendation of the part to be ordered by utilizing a plurality of evaluation items every part to be ordered, and present the degree of recommendation to the person in charge of ordering.

According to JP-A-2008-159023, however, it is possible to evaluate the performance and quality of a part with respect to a supplier which conducts direct transaction with the ordering enterprise taken as an object. For example, however, the same parts or equivalent parts are ordered from a plurality of suppliers, in some cases. If in this case suppliers (secondary suppliers or subordinate suppliers) located beyond each supplier are the same supplier and supply from the secondary supplier to the primary supplier is stagnated because of the above-described causes, then there is a fear that supply from the primary supplier to the ordering enterprise will also be stagnated and it cannot be evaluated and avoided previously.

Therefore, the present invention provides a method for calculating the procurement risk for the secondary and subordinate suppliers accurately and quickly and assisting procurement intension determination.

In order to solve the above-described problem, for example, a configuration described in claims is adopted.

The present application includes a plurality of units in order to solve the problem. An example of them will now be described. A procurement risk calculation apparatus includes a control unit which receives ordering information of a part originated by an orderer, via a network, BOM information which is configuration information of the part, and ordering detail history information included in electronic commercial transaction information, an operation unit which extracts a part for which plural corporation purchase is conducted from the ordering information, extracts order receiver enterprises names (secondary suppliers) of parts respectively of primary suppliers from the BOM information and the ordering detail history information, and conducts processing of calculating a procurement risk, such as distribution of order receiver enterprises (the degree of concentration of secondary suppliers and subsequent suppliers) of respective parts, as a terminal supplier risk, and an output processing unit which outputs a result of the terminal supplier risk calculation processing.

When ordering a part, it becomes possible to calculate the risk of procurement from the secondary and subordinate suppliers accurately and quickly. By conducting intention determination concerning ordering contents such as the procurement supplier and the part utilizing the result of the calculation, an effect of quality improvement of the procured part such as improvement of the observance rate of the delivery time and improvement of the inspection passing rate can be anticipated. Furthermore, owing to the present invention, it becomes possible to implement the productivity improvement of the risk study business in the procurement business and continue the business when various troubles have occurred.

Other objects, features and advantages of the invention will become apparent from the following description of the embodiments of the invention taken in conjunction with the accompanying drawings.

### BRIEF DESCRIPTION OF THE DRAWINGS

FIG. 1 is a diagram showing a configuration example of a procurement risk calculation apparatus;

FIG. 2 is a diagram showing a configuration example of hardware of the present system;

FIG. 3 is a diagram showing an example of a processing flow in the procurement risk calculation apparatus;

FIG. 4 is a diagram showing a configuration example of an input screen;

FIG. 5 is a diagram showing a configuration example of ordering information;

FIG. 6 is a diagram showing a configuration example of a plural corporation purchase part information storage unit;

FIG. 7 is a diagram showing a flow example of terminal supplier risk calculation preprocessing;

FIG. 8 is a diagram showing a configuration example of an external information storage device;

FIG. 9 is a diagram showing a configuration example of BOM information;

FIG. 10 is a diagram showing a configuration example of a BOM information storage unit;

FIG. 11 is a diagram showing a configuration example of ordering detail history information;

FIG. 12 is a diagram showing a configuration example of an ordering detail history information storage unit;

FIG. 13 is a diagram showing a configuration example of terminal supplier totalization information;

FIG. 14 is a diagram showing a configuration example of a terminal supplier risk information storage unit;

FIG. 15 is a diagram showing a configuration example of an output screen;

FIG. 16 is a diagram showing a configuration example of an output screen;

FIG. 17 is a diagram showing a configuration example of a delivery time observance information storage unit;

FIG. 18 is a diagram showing a configuration example of a procurement risk information storage unit;

FIG. 19 is a diagram showing a configuration example of a procurement risk calculation apparatus;

FIG. 20 is a diagram showing a processing flow of a procurement risk calculation apparatus;

FIG. 21 is a diagram showing a configuration example of an external storage device;

FIG. 22 is a diagram showing a flow example of supplier share totalization processing;

FIG. 23 is a diagram showing a configuration example of part share information;

FIG. 24 is a diagram showing a configuration example of a part share information storage unit;

FIG. 25 is a diagram showing a configuration example of supplier share totalization information;

FIG. 26 is a diagram showing a configuration example of a terminal supplier risk information storage unit; and

FIG. 27 is a diagram showing a configuration example of an output screen.

### DESCRIPTION OF THE EMBODIMENTS

Hereafter, embodiments will be described with reference to the drawings. In the present embodiment, an example of an apparatus and a method for calculating procurement risks of secondary suppliers concerning order contents accurately and quickly and present the calculated procurement risks to an orderer when the orderer conducts ordering business will be described.

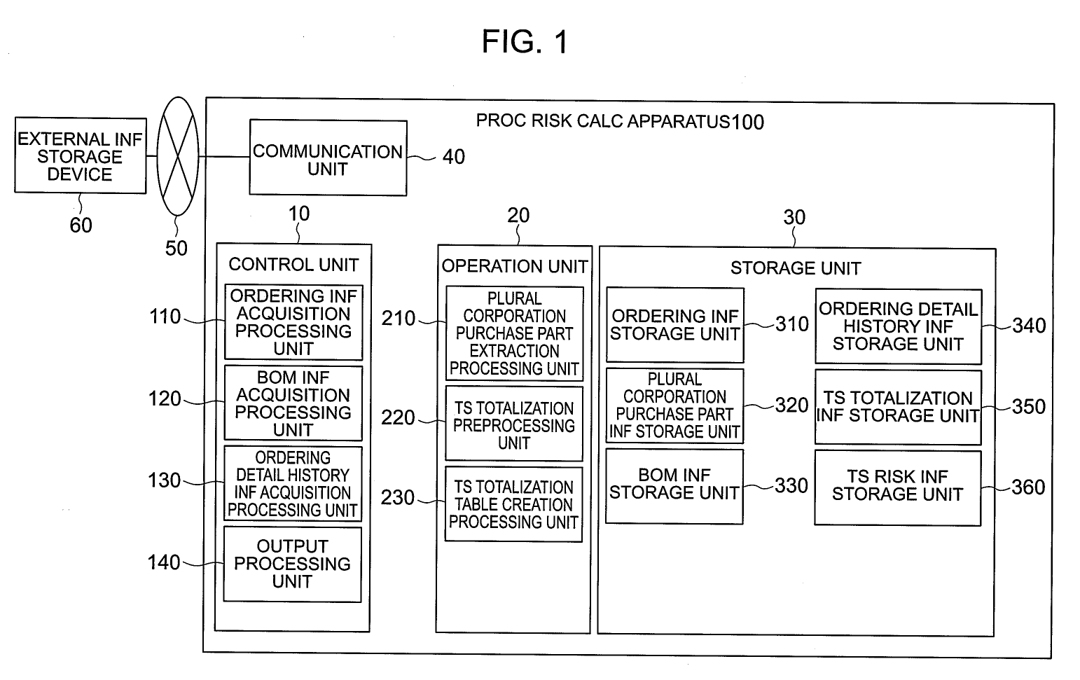

FIG. 1 is a diagram showing a configuration example of a procurement (proc) risk calculation (calc) apparatus 100 according to an embodiment of the present invention. The procurement risk calculation apparatus 100 in the present embodiment 1 includes a control unit 10, an operation unit 20, a storage unit 30, and a communication unit 40. Information required for processing in the operation unit 20 can be acquired from an external information (inf) storage device 60 via a network 50 by using the communication unit 40 as an interface. The network 50 is typically a communication network managed by an organization of users such as a LAN (Local Area Network). However, the network 50 is not restricted to this, but the network 50 may be a communication network which partially uses a public communication network such as Internet, or a common public line such as the WAN (Wide Area Network) or VPN (Virtual Private Network). The control unit 10 receives ordering information concerning a part transmitted by an orderer, by using an ordering information acquisition processing unit 110, receives information concerning configuration information of the part via the network 50 by using a BOM information acquisition processing unit 120, receives ordering detail information concerning past order history by using an ordering detail history information acquisition processing unit 130, requests the operation unit 20 to conduct operation processing which will be described later, receives information concerning a result of the processing, and presents the result to the orderer via an output processing unit 140.

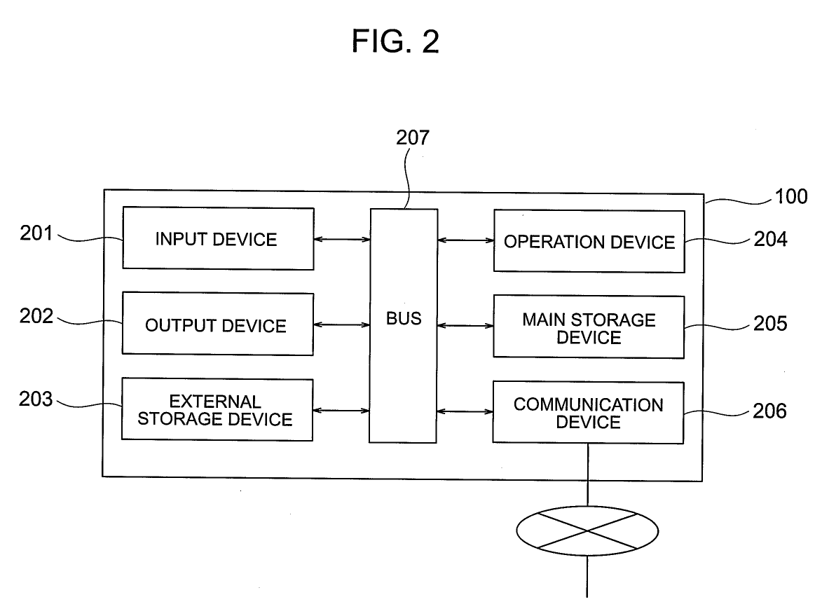

FIG. 2 is a diagram showing a hardware configuration example of the procurement risk calculation apparatus 100. In the present embodiment, the procurement risk calculation apparatus 100 is a device such as, for example, a PC (personal computer), a work station, a server device, a smart phone, or a tablet terminal. The procurement risk calculation apparatus 100 includes an input device 201, an output device 202, an external storage device 203, an operation device 204, a main storage device 205, a communication device 206, and a bus 207 which connects the devices to each other. The input device 201 is for example, a keyboard, a mouse, a touch pen, an information reading device such as a pointing device or bar code reader, or a device receiving a voice input. The output device 202 is a device which conducts display, such as a display device. The external storage device 203 is a nonvolatile storage device such as, for example, a hard disk device or a flash memory. The operation device 204 is an operation device such as, for example, a CPU (Central Processing Unit). The main storage device 205 is a memory device such as, for example, a RAM (Random Access Memory). The communication device 206 is a wireless communication device which conducts wireless communication via an antenna, or a wire communication device which conducts wire communication via a network cable.

The storage unit 30 in the procurement risk calculation apparatus 100 is implemented by the main storage device 205 or the external storage device 203 in the procurement risk calculation apparatus 100. The control unit 10 and the operation unit 20 in the procurement risk calculation apparatus 100 are implemented by a program which causes the operation device 204 in the procurement risk calculation apparatus 100 to conduct processing. This program is stored in the main storage device 205 or the external storage device 203, loaded onto the main storage device 205, and executed by the operation device 204. The communication unit 40 in the procurement risk calculation apparatus 100 is implemented by the communication device 206 in the procurement risk calculation apparatus 100. When ordering a part, the orderer reports contents of order to the procurement risk calculation apparatus 100.

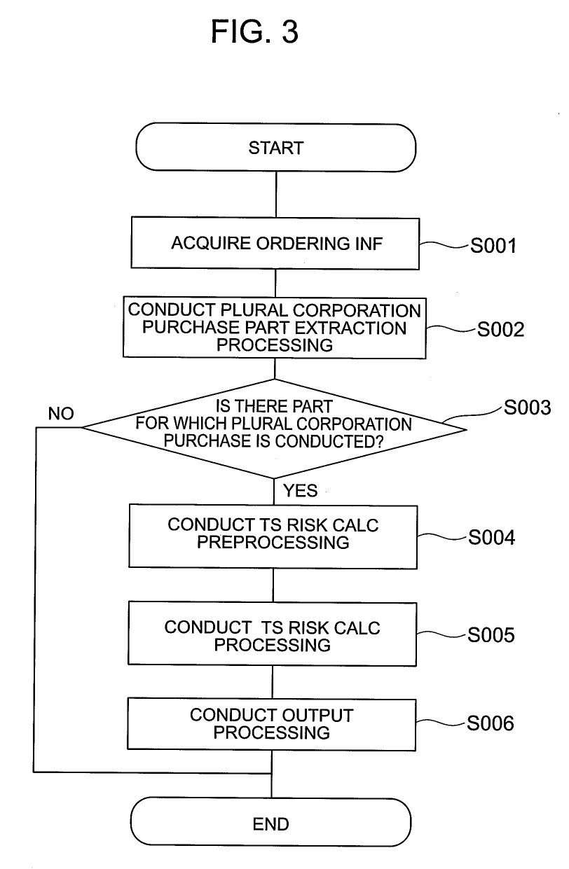

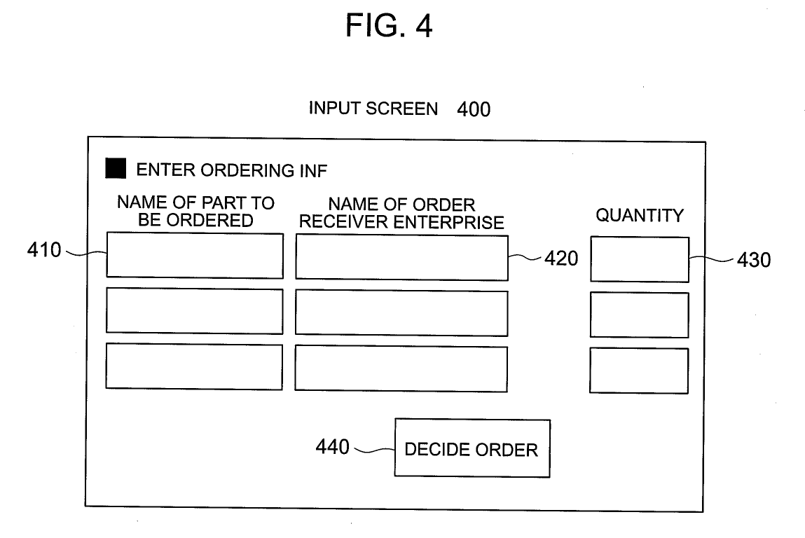

FIG. 3 is a diagram showing an example of a processing flow in the control unit 10 and the operation unit 20 in the procurement risk calculation apparatus 100. The ordering information acquisition processing unit 110 receives a request to start ordering (including ordered part, name of order receiver enterprise, and order quantity) processing from an orderer, and the output processing unit 140 configures an input screen 400 shown in FIG. 4 and causes the output device 202 to display the screen. As a result, each processing in the operation unit 20 is started.

First, the operation unit 20 receives an ordered part name, an order receiver enterprise name, and a quantity as ordering information generated newly by an orderer, and stores the ordered part name, the order receiver enterprise name, and the quantity into an ordering information storage unit 310 (step S001). Specifically, the operation unit 20 stores a value in an ordered part name input area 410 accepted on the input screen 400 into an ordered part name 311 in the ordering information storage unit 310, a value in an order receiver enterprise name input area 420 into an order receiver enterprise name 312 in the ordering information storage unit 310, and a value in a quantity input area 430 into a quantity 313 in the ordering information storage unit 310.

The input screen 400 for accepting inquiry information generated newly from a user will now be described. FIG. 4 is a diagram showing a configuration example of the input screen 400. The input screen 400 includes the ordered part name input area 410, the order receiver enterprise name input area 420, the quantity input area 430, and an order decision button 440 for deciding input contents. The ordered part name input area 410 is an area for accepting a name of an ordered part included in ordering information. The information accepted in the ordered part name input area 410 may be character information given by the orderer, or may be a name of a part ordered last time. Or a value selected out of a plurality of part names displayed previously as a list may be received. At that time, there is a method of previously storing a list of parts having a possibility of being ordered or parts ordered actually in the past into the external information storage device 60 or the storage unit 30 and acquiring a part name when starting the present processing. The order receiver enterprise name input area 420 is an area for accepting the name of an enterprise of an ordering receiver (purchase receiver) of the part included in the ordering information. The name in the order receiver enterprise name input area 420 may be a name of an order receiver enterprise in an order given last time. Or a value selected out of a plurality of candidates of an order receiver enterprise displayed previously as a list may be received. At that time, there is a method of previously storing a list of names of order receiver enterprises having a possibility of being ordered or names of order receiver enterprises ordered actually in the past into the external information storage device 60 or the storage unit 30 and acquiring a name of an order receiver enterprise when starting the present processing. The quantity input area 430 is an area for accepting the quantity information included in the ordering information. The order decision button 440 is a decision button for storing information input to the ordered part name input area 410, the order receiver enterprise name input area 420, and the quantity input area 430 into the ordering information storage unit 310.

In generating the information accepted in the ordered part name input area 410 and the order receiver enterprise name input area 420 in the present embodiment, the orderer may directly input the information or information selected out of listed information may be accepted as described above. Besides them, contents of the order may be automatically converted to text data and accepted by using a voice input function, or may be accepted by using an input terminal such as a bar code.

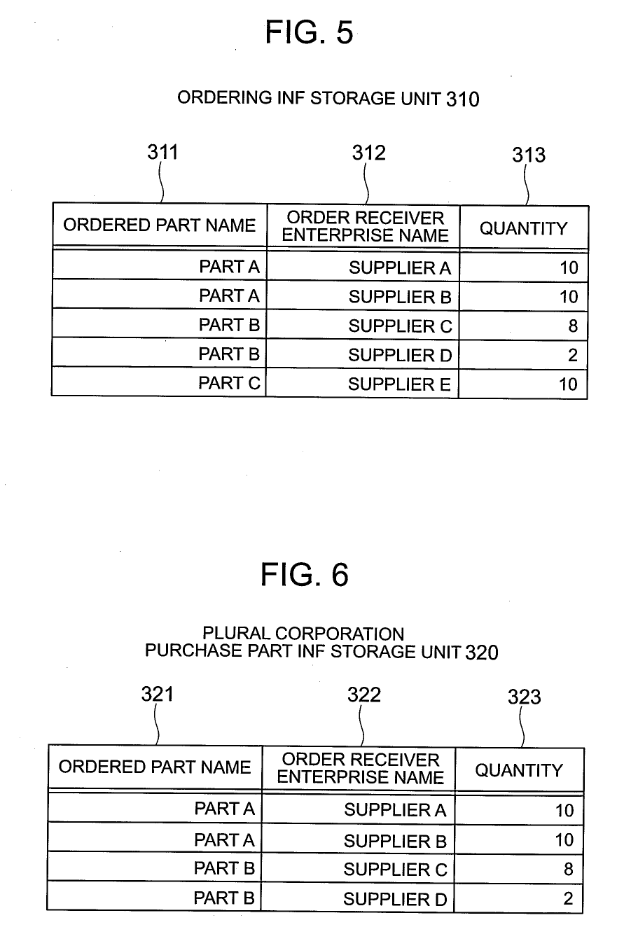

FIG. 5 is a diagram showing a configuration example of the ordering information storage unit 310. The ordering information storage unit 310 stores various kinds of information accepted by the ordering information acquisition processing unit 110. The ordering information acquisition processing unit 110 stores at least the ordered part name 311, the order receiver enterprise name 312, and the quantity 313. The ordered part name 311 is a column for storing a name of an ordered part. The ordered part name 311 is a column for storing information accepted in the ordered part name input area 410 on the input screen 400. The order receiver enterprise name 312 is a column for storing an order receiver enterprise name of the ordered part. The order receiver enterprise name 312 is a column for storing information accepted in the order receiver enterprise name input area 420 on the input screen 400. The quantity 313 is a column for storing an order quantity of the ordered part. The quantity 313 is a column for storing information accepted in the quantity input area 430 on the input screen 400. For example, according to a first record in the present table (a second line in the table), it is appreciated that in the order contents the ordered part name is “part A,” the order receiver enterprise name is “supplier A,” and the quantity is “10.” In other words, it is appreciated that “part A” representing the ordered part name is stored in the ordered part name 311, “supplier A” representing the order receiver enterprise name is stored in the order receiver enterprise name 312, and “10” representing the order quantity is stored in the quantity 313.

Then, the operation unit 20 extracts parts ordered from a plurality of enterprises which are at least two corporations, from ordering information accepted at the step S001 and stored in the ordering information storage unit 310 (step S002). Specifically, the operation unit 20 reads the ordering information stored in the ordering information storage unit 310, and stores a result of processing conducted in a plural corporation purchase part extraction processing unit 210 into a plural corporation purchase part information storage unit 320 in the storage unit 30.

Processing conducted by the plural corporation purchase part extraction processing unit 210 at the step S002 will now be described. At the step S002, data extracted from the ordering information storage unit 310 by processing conducted in the plural corporation purchase part extraction processing unit 210 in the operation unit 20 is stored into the plural corporation purchase part information storage unit 320. Specifically, values in the ordered part name 311 in all records stored in the ordering information storage unit 310 are compared, and records which are the same in part name and the order receiver enterprise in the order receiver enterprise name 312 is at least two corporations are extracted. For example, according to a first record in a table stored in the ordering information storage unit 310 (a second line in the table), it is appreciated that an ordered part name “part A” is ordered from an order receiver enterprise name “supplier A.” Referring to the ordered part name 311 in the next record, it is appreciated that the same “part A” as that in the preceding record is ordered from an order receiver enterprise name “supplier B.” In other words, the same “part A” is ordered from the two corporations “supplier A” and “supplier B.” The ordered part name 311, the order receiver enterprise name 312, and the quantity 313 in records in which plural corporation purchase is being conducted in this way are stored into an ordered part name 321, an order receiver enterprise name 322, and a quantity 323 in the plural corporation purchase part information storage unit 320. Referring to the ordered part name 311 in another record in the ordering information storage unit 310, an ordered part name “part C” is ordered from an order receiver enterprise name “supplier E.” Even if data in the present record and subsequent records are viewed, a record in which the “part C” is ordered from a corporation other than the “supplier E” cannot be found. Therefore, as for the “part C,” it is judged that plural corporation purchase is not conducted. Accordingly, the “part C” is not included in plural corporation purchase part information.

The plural corporation purchase part information storage unit 320 which stores the result of the processing conducted at the step S002 will now be described. FIG. 6 is a diagram showing a configuration example of the plural corporation purchase part information storage unit 320. The plural corporation purchase part information storage unit 320 stores at least the ordered part name 321, the order receiver enterprise name 322, and the quantity 323. The ordered part name 321 is a column for storing a part name for which plural corporation purchase is conducted, extracted by the plural corporation purchase part extraction processing unit 210. The order receiver enterprise name 322 is a column for storing an order receiver enterprise name of a part for which plural corporation purchase is conducted, extracted by the plural corporation purchase part extraction processing unit 210. The quantity 323 is a column for storing an order quantity of a part for which plural corporation purchase is conducted, extracted by the plural corporation purchase part extraction processing unit 210. For example, according to a first record (a second line in the table), it is appreciated that in the order contents the ordered part name is “part A,” the order receiver enterprise name is “supplier A,” and the quantity is “10.” In other words, it is appreciated that “part A” representing the ordered part name is stored in the ordered part name 321, “supplier A” representing the order receiver enterprise name is stored in the order receiver enterprise name 322, and “10” representing the order quantity is stored in the quantity 323.

Then, the operation unit 20 makes a decision whether there is a part for which plural corporation purchase is conducted, on the basis of the ordering information stored in the plural corporation purchase part information storage unit 320 as a result of the processing conducted by the plural corporation purchase part extraction processing unit 210 at the step S002 (step S003). Specifically, the decision is made on the basis of whether there are at least two records having the same part name in the table stored in the plural corporation purchase part information storage unit 320. In other words, if there are no records in the table in the plural corporation purchase part information storage unit 320, then it is judged that there are no plural corporation purchase parts in the ordering information and the processing is finished. If there is a record in the table in the plural corporation purchase part information storage unit 320, then it is judged that there is a plural corporation purchase part in the ordering information and the processing proceeds to the next step.

Then, the operation unit 20 conducts preprocessing for calculating a procurement risk for a plural corporation purchase part on the basis of ordering information of plural corporation purchase stored in the plural corporation purchase part information storage unit 320, configuration information of a part stored in BOM (Bills of Materials; part table) information 610, and past order history information stored in ordering detail history information 620, in its terminal supplier (TS) totalization preprocessing unit 220 (step S004).

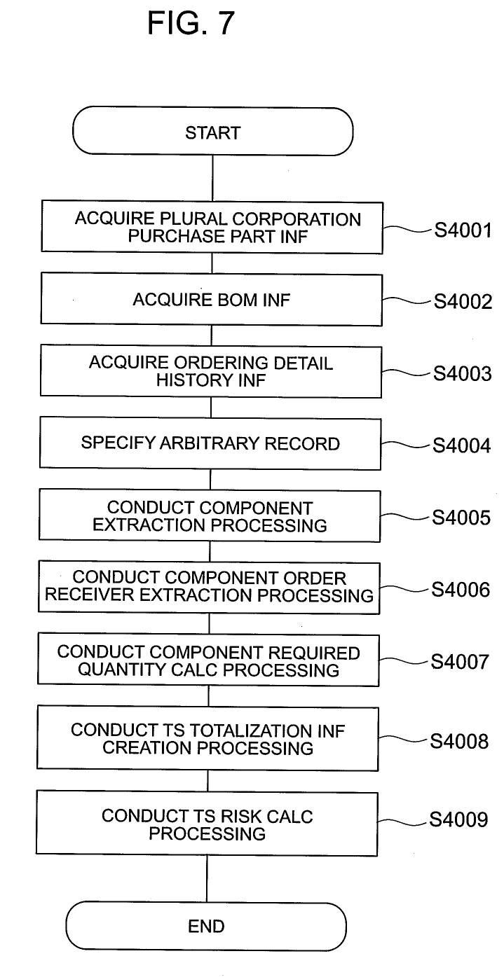

The preprocessing (the step S004) for calculating a procurement risk for a plural corporation purchase part conducted in the terminal supplier totalization preprocessing unit 220 will now be described in detail. FIG. 7 shows a flow example of preprocessing for calculating a terminal supplier risk.

First, the operation unit 20 extracts all records for plural corporation purchase parts from the plural corporation purchase part information storage unit 320 (step S4001). Then, the BOM information acquisition processing unit 120 receives the BOM information 610 from the external information storage device 60, extracts only records corresponding to the parts included in the plural corporation purchase part information storage unit 320, and stores the records into a BOM information storage unit 330 in the storage unit 30 (step S4002).

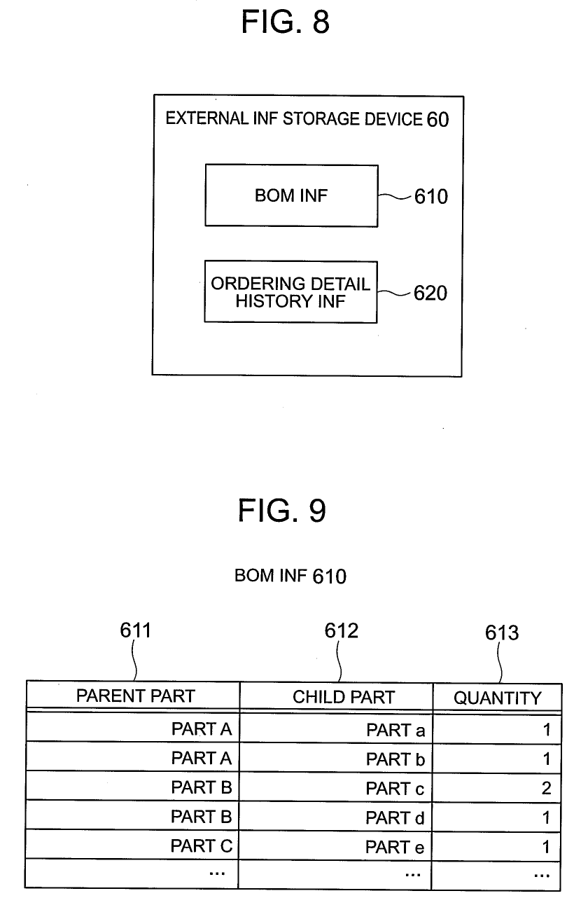

The BOM information 610 stored in the external information storage device 60 as shown in FIG. 8, and the BOM information storage unit 330 will now be described. FIG. 9 is a diagram showing a configuration example of BOM information 610 stored in the external information storage device 60. The BOM information 610 stores at least a parent part 611, a child part 612, and a quantity 613. The parent part 611 is a column for storing a name of a part ordered from a supplier. The child part 612 is a column for storing a name of a part which constitutes a parent part. The quantity 613 is a column for storing a requisite quantity of a child part which constitutes a parent part. For example, according to a first record in the present table (a second line in the table), it is appreciated that in contents the ordered parent part “part A” uses “part a” which is “1” in quantity as its component. In other words, it is appreciated that “part A” representing the parent part name is stored in the parent part 611, “part a” representing the child part name is stored in the child part 612, and “1” representing its required quantity is stored in the quantity 613. Furthermore, in the BOM information 610, it is appreciated from the child part column 612 that child parts which are components of the parent part “part A” stored in the parent part 611 are “part a” and “part b.” In addition, it is appreciated from the quantity column 613 that “part a” and “part b” which are respectively “1” and “1” in quantity are required to produce one parent part “part A.”

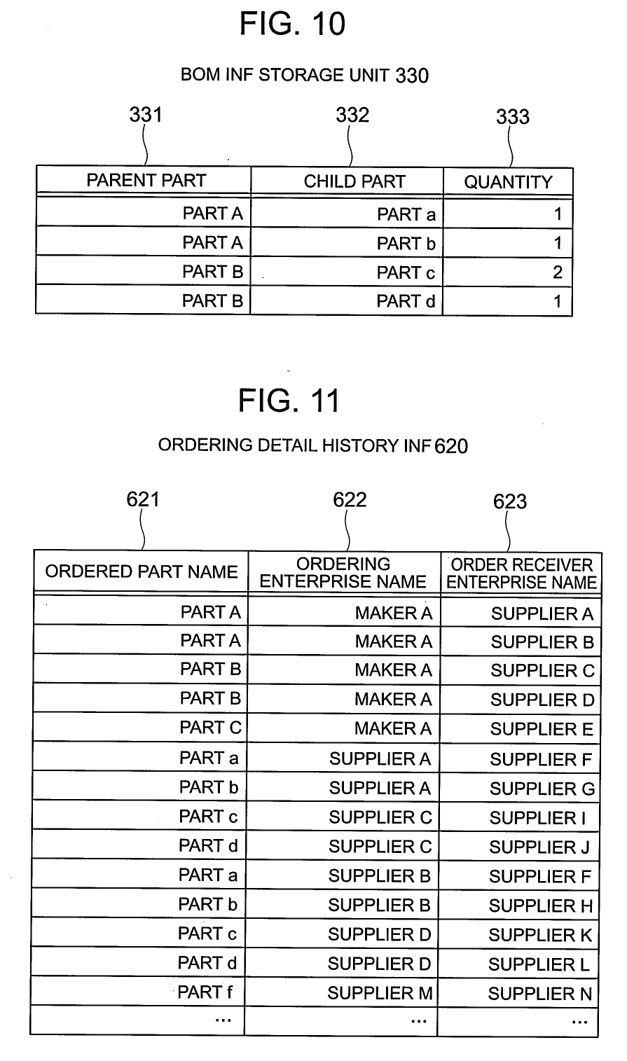

FIG. 10 is a diagram showing a configuration example of the BOM information storage unit 330 stored in the storage unit 30. Only records corresponding to the parts included in the plural corporation purchase part information storage unit 320 are stored in the BOM information storage unit 330. The BOM information storage unit 330 stores at least a parent part 331, a child part 332, and a quantity 333. The parent part 331 is a column for storing a name of a part ordered from a supplier. The child part 332 is a column for storing a name of a part which constitutes a parent part. The quantity 333 is a column for storing a required quantity of a child part which constitutes a parent part. For example, according to a first record in the present table (a second line in the table), it is appreciated that in contents the ordered parent part “part A” uses “part a” which is “1” in quantity as its component. In other words, it is appreciated that “part A” representing a parent part name is stored in the parent part 331, “part a” representing a child part name is stored in the child part 332, and “1” representing a required quantity of the child part is stored in the quantity 333.

Then, the ordering detail history information acquisition processing unit 130 in the control unit 10 receives the ordering detail history information 620 from the external information storage device 60, extracts only records corresponding to the parts included in the plural corporation purchase part information storage unit 320, and stores the records into an ordering detail history information storage unit 340 in the storage unit 30 (step S4003).

The ordering detail history information 620 and the ordering detail history information storage unit 340 will now be described. FIG. 11 is a diagram showing a configuration example of the ordering detail history information 620 stored in the external information storage device 60 as shown in FIG. 8. The ordering detail history information 620 stores at least, an ordered part name 621, an ordering enterprise name 622, and an order receiver enterprise name 623. The ordered part name 621 is a column for storing an ordered part name in ordering information generated in the past. The ordering enterprise name 622 is a column for storing an ordering enterprise name of a part included in ordering information generated in the past. The order receiver enterprise name 623 is a column for storing an order receiver enterprise name of a part included in ordering information generated in the past. For example, according to a first record in the present table (a second line in the table), it is appreciated that an ordered part name “part A” is contents ordered from an order receiver enterprise “supplier A” by an ordering enterprise name “maker A.” In other words, it is appreciated that “part A” representing the ordered part name is stored in the ordered part name 621, “maker A” representing the ordering enterprise name is stored in the ordering enterprise name 622, and “supplier A” representing the order receiver enterprise is stored in the order receiver enterprise name 623. Information representing past transaction generation date and hour may be added to the ordering detail history information 620 besides the above-described information. Furthermore, information such as transaction contents, the delivery time, the result of inspection and acceptance may also be stored.

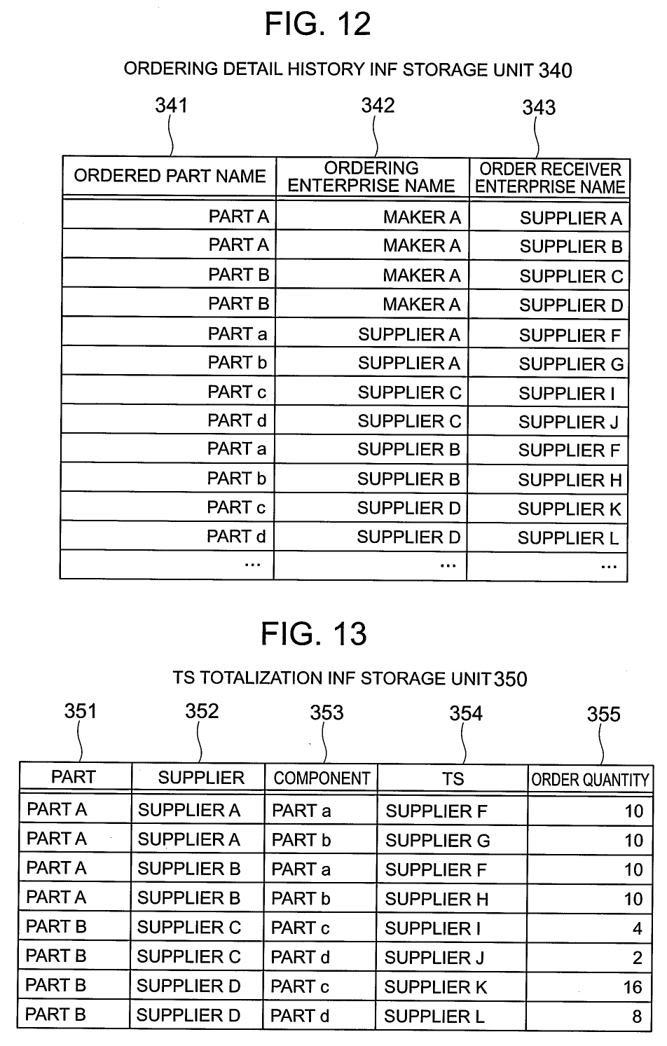

FIG. 12 is a diagram showing a configuration example of the ordering detail history information storage unit 340 stored in the storage unit 30. Only records corresponding to the parts included in the plural corporation purchase part information storage unit 320 are stored in the ordering detail history information storage unit 340. The ordering detail history information storage unit 340 stores at least, an ordered part name 341, an ordering enterprise name 342, and an order receiver enterprise name 343. The ordered part name 341 is a column for storing an ordered part name in ordering information generated in the past. The ordering enterprise name 342 is a column for storing an ordering enterprise name of a part included in the ordering information generated in the past. The order receiver enterprise name 343 is a column for storing an order receiver enterprise name of a part included in the ordering information generated in the past. For example, according to a first record in the present table (a second line in the table), it is appreciated that in contents ordered part name “part A” is ordered from an order receiver enterprise “supplier A” by an ordering enterprise name “maker A.” In other words, it is appreciated that “part A” representing ordered part name is stored in the ordered part name 341, “maker A” representing the ordering enterprise name is stored in the ordering enterprise name 342, and “supplier A” representing the order receiver enterprise is stored in the order receiver enterprise name 343. Information representing occurrence date and hour of past transactions may be added to the ordering detail history information storage unit 340 besides the above-described information. In that case, as for information stored in the ordering history detail, information in an arbitrary time period in the past traced back from a time point of newly generated ordering can be utilized. For example, data over one week in the past from the time point of occurrence may be added, data over one month in the past from the time point of occurrence may be added, or data over one year in the past from the time point of occurrence may be added. Or data traced back at least one year may be added. Furthermore, information such as transaction contents, the delivery time, the result of inspection and acceptance may also be stored.

Then, one arbitrary record is extracted from the plural corporation purchase part information storage unit 320 and retained by the main storage device 205 (step S4004). Then, a record coinciding with an ordered part name 321 included in the arbitrary record extracted at the step S4004 is acquired from the BOM information storage unit 330 (step S4005). Then, a record coinciding a part included in the record acquired at the step S4005 and an order receiver enterprise name included in the record in the plural corporation purchase part information storage unit 320 selected at the step S4004 is acquired from the ordering detail history information 620 stored in the storage unit 30 (step S4006). Then, an ordered part name 321 and an order receiver enterprise name 322 included in the arbitrary record in the plural corporation purchase part information storage unit 320 acquired at the step S4004, a child part name 612 acquired from the BOM information 610 at the step S4005, and an order receiver enterprise name 623 acquired from the ordering detail history information 620 at the step S4006 are stored in a terminal supplier totalization information storage unit 350 in the storage unit 30 (S4007).

The terminal supplier totalization information storage unit 350 in the storage unit 30 will now be described. FIG. 13 is a diagram showing a configuration example of the terminal supplier totalization information storage unit 350 in the storage unit 30. The terminal supplier totalization information storage unit 350 stores at least a part 351, a supplier 352, a component 353, a terminal supplier 354, and an order quantity 355. The part 351 is a column for storing a name of an ordered part included in the arbitrary record selected at the step S4004. The supplier 352 is a column for storing the order receiver enterprise name included in the arbitrary record selected at the step S4004. The component 353 is a column for storing a child part included in the BOM information 610 extracted at the step S4005. The terminal supplier 354 is a column for storing the order receiver enterprise name included in the ordering detail history information 620 extracted at the step S4006. The order quantity 355 is a column for storing a value returned at step S4008 which will be described later. For example, according to a first record in the present table (a second line in the table), it is appreciated that in contents an ordered part “part A” is ordered from “supplier A,” “part a” which is one of parts constituting the “part A” is ordered from “supplier F” and the order quantity is “10.” In other words, it is appreciated that “part A” representing the ordered part name is stored in the part 351, “supplier A” representing the order receiver enterprise is stored in the supplier 352, “part a” representing the component is stored in the component 353, “supplier F” representing the terminal supplier is stored in the terminal supplier 354, and “10” representing the order quantity is stored in the order quantity 355.

A calculation processing method of the value stored in the order quantity 355 column in the terminal supplier totalization information storage unit 350 will now be described. A result obtained by multiplying the quantity 323 in the arbitrary record specified in the plural corporation purchase part information storage unit 320 and obtained at the step S4004 by the quantity 613 in the BOM information extracted at the step S4005 is stored in the order quantity 355 in the terminal supplier totalization information storage unit 350 (step S4008).

Specifically, all records in the plural corporation purchase part information storage unit 320 stored in the storage unit 30 are extracted and retained on the memory at the step S4001. Then, at the step S4002, the BOM information acquisition processing unit 120 extracts only records coinciding with the ordered part name 321 included in the plural corporation purchase part information storage unit 320 from the BOM information 610 stored in the external information storage device 60, and stores the records into the BOM information storage unit 330 in the storage unit 30. In the case of the present example, records concerning “part A” and “part B” are stored in the ordered part name 321 column in the plural corporation purchase part information storage unit 320. Therefore, the BOM information acquisition processing unit 120 extracts only records concerning “part A” and “part B” from the BOM information 610 and stores the records into the BOM information storage unit 330. Then, at the step S4003, the ordering detail history information acquisition processing unit 130 extracts records which include, in the ordered part name 621 column, part names included in the parent part 331 and the child part 332 in the BOM information storage unit 330, from the ordering detail history information 620, and stores the records into the ordering detail history information storage unit 340. In the case of the present example, “part A,” “part B,” “part a,” “part b,” “part c” and “part d” are included in the parent part 331 and the child part 332 in the BOM information storage unit 330. Records including any of these part names in the ordered part name 621 column are extracted and stored into the ordering detail history information storage unit 340. Then, at the step S4004, an arbitrary record is extracted out of records stored in the plural corporation purchase part information storage unit 320. In the present example, the first record (part A, supplier A, and 10) is acquired. Then, at the step S4005, the parent part name 611 in the BOM information 610 is searched by using the “part A” stored in the ordered part name 321 in the record acquired at the step S4004 as a key. In the case of the present example, the BOM information 610 is searched for the “part A.” As a result, a first record (part A and part a) in the BOM information 610 is extracted. At the step S4006, the ordering enterprise name 622 and the ordered name 621 in the ordering detail history information 620 are searched by using the “supplier A” stored in the order receiver enterprise name 322 in the record acquired at the step S4004 and the child part name 612 “part a” acquired at the step S4005 as a key. In the case of the present example, a search is made by using the “part a” and the “supplier A” as a key. As a result, a sixth record (part a, supplier A, and supplier F) in the ordering detail history information 620 is extracted. Then, at the step S4007, data (part A, supplier A, part a, and supplier F) extracted and retained at the step S4005 and the step S4006 are stored into the terminal supplier totalization information storage unit 350. At the step S4008, a result obtained by multiplying “10” stored in the quantity 323 column in the record which is extracted at the step S4004 by “1” stored in the quantity 613 column in the record which is extracted at the step S4005 is stored in the order quantity 355 in the terminal supplier totalization information storage unit 350. Returning to the step S4005, similar processing is also conducted for “part b” which is a component of the part A. Upon finishing similar processing for all components of the part A, the processing returns to the step S4004 and processing concerning “supplier B” of “part A” is conducted in the same way. Such processing is repeated. Details of the processing at the step S004 has been described heretofore.

Then, the operation unit 20 receives the terminal supplier totalization information storage unit 350 which is the processing result at the step S004, and conducts processing in a terminal supplier totalization table creation processing unit 230 (step S005). Specifically, for example, operation processing which will be described later is conducted on the data stored in the terminal supplier totalization information storage unit 350, and its result is stored into a terminal supplier risk information storage unit 360 in the storage unit 30. The procurement risk in the present embodiment is obtained by calculating the degree of concentration of terminal suppliers supplying parts which constitute a part ordered by the ordering enterprise. For calculating the procurement risk, therefore, it is necessary to calculate a ratio at which each of components of an ordered part is supplied by each of secondary and subsequent suppliers. Therefore, the terminal supplier risk information storage unit 360 stores a result of totalizing a ratio at which each of components is ordered from each of secondary suppliers every ordered part.

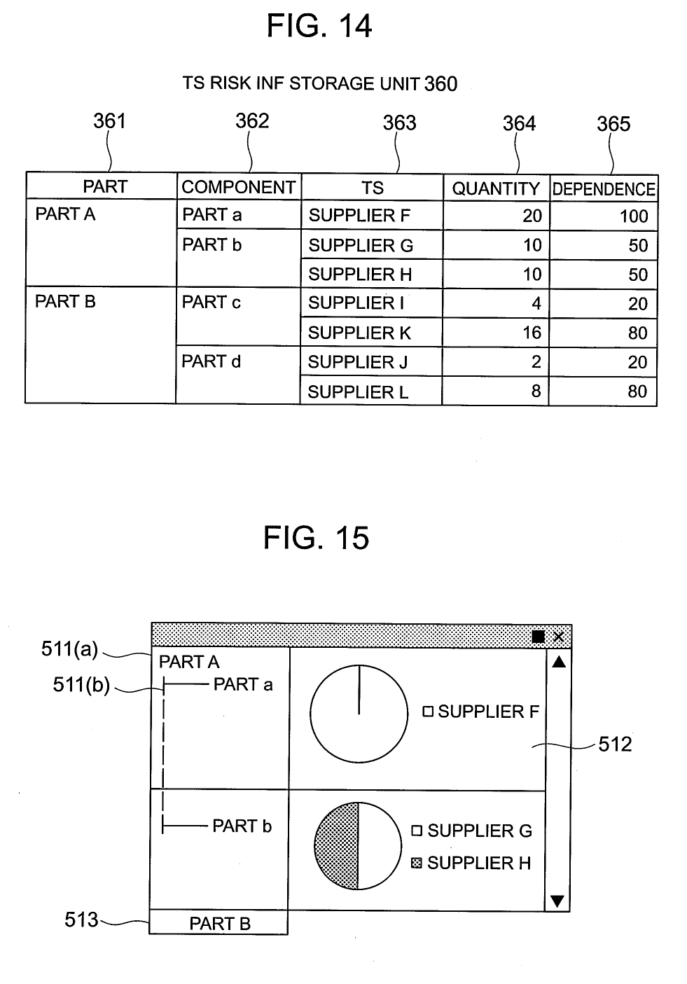

FIG. 14 is a diagram showing a configuration example of the terminal supplier risk information storage unit 360. The terminal supplier risk information storage unit 360 stores at least a part 361, a component 362, a terminal supplier 363, a quantity 364, and dependence 365. The part 361 is a column for storing a part name which becomes an object of procurement risk evaluation. The component 362 is a column for storing a component name of the part which becomes the object of procurement risk evaluation. The terminal supplier 363 is a column for storing an order receiver enterprise of a part constituting the part which becomes the object of procurement risk evaluation. The quantity 364 is a column for storing a quantity of a part constituting the part which becomes the object of procurement risk evaluation ordered from each order receiver. The dependence 365 is a column for storing a value indicating dependence of a part constituting the part which becomes the object of procurement risk evaluation upon an order receiver. For example, according to the present table, “part a” which is a component of “part A” is ordered only from “supplier F” in a quantity of “20.” In other words, since the order receiver of the “part a” is only “supplier F,” it is appreciated that the dependence upon the “supplier F” is “100.” In the same way, “part b” which is a component of “part A” is ordered from “supplier G” and “supplier H” respectively in quantities of “10” and “10.” From this, it is appreciated that the “part b” is ordered dispersedly from “supplier G” and “supplier H.”

The method for calculating the dependence will now be described. The dependence which indicates distribution of order receiver of a part which constitutes an ordered part as described above is calculated by using, for example, the following method.

Dependence of a part i upon a supplier=(quantity ordered from the supplier/required quantity)*100(%)

The quantity of “part a” required to produce “part A” is “20” and the quantity ordered from “supplier F” is “20.” Therefore, the dependence of “part a” upon “supplier F” becomes (20/20)*100=100(%). (“*” is a multiplication operator.) In the same way, as for “part b,” the required quantity of “part b” is “20=10+10” and the quantity ordered from “supplier G” is “10.” Therefore, the dependence of “part b” upon “supplier G” becomes (10/20)*100=50(%).

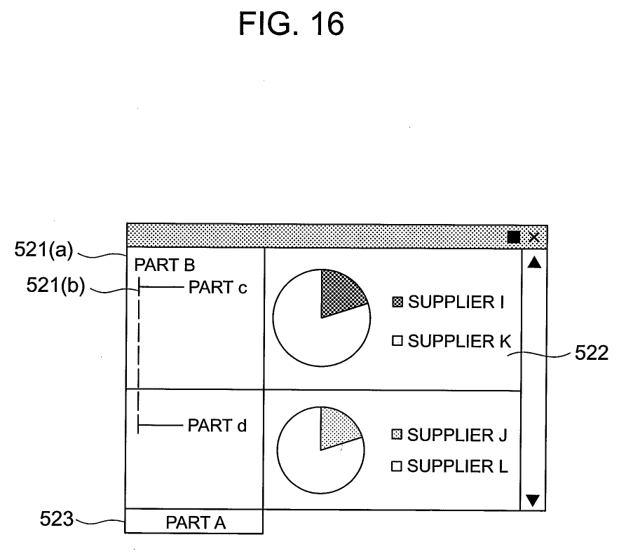

Then, the operation unit 20 receives information stored in the terminal supplier risk information storage unit 360, which is the processing result at the step S005, and conducts output processing in the output processing unit 140 in the control unit 10 (step S006). Specifically, the operation unit 20 receives information in the terminal supplier risk information storage unit 360, and the output processing unit 140 constitutes an output screen 510 shown in FIG. 15 and an output screen 520 shown in FIG. 16, and causes the output device 202 to display the screen.

FIG. 15 is a diagram showing a configuration example of the output screen 510. The output screen 510 includes a tree display unit 511, a graph display unit 512, and a display changeover tab button 513. The tree display unit 511 is an area for displaying a parent-child configuration of a part which becomes an object of procurement risk evaluation, in a tree form. In the tree display unit 511, the relation between the part 361 and the component 362 can be displayed in a tree form. Specifically, “part A” stored in the part 361 is displayed in 511(a) in the tree display unit 511, and “part a” and “part b” stored in the component 362 are displayed in 511(b) in the tree display unit 511. The graph display unit 512 can conduct graph display of the dependence 365 in the terminal supplier risk information storage unit 360 corresponding to 511(b) in the tree display unit 511. Specifically, the dependence 365 upon the supplier stored in the terminal supplier 363 is displayed in the graph display unit 512 by using, for example, a circle graph. The display changeover tab button 513 is a button for executing changeover of an object part of procurement risk evaluation. Specifically, if the display changeover tab button 513 is selected, a transition to FIG. 16 showing a procurement risk evaluation result concerning “part B” is made.

FIG. 16 is a screen showing a procurement risk calculation result in “part B.” Its screen configuration and display method are similar to those in FIG. 15, and consequently description of them will be omitted.

The dependence of the “part a” which is a component of “part A” upon the supplier F is 100. The circle graph shown in FIG. 15 also represents that the dependence upon the supplier F is 100. For example, in the case where the dependence is 100, the procurement risk is great. Therefore, a warning that it is necessary to reconsider the procurement receiver of the “part A” may be displayed in the display screen shown in FIG. 15. A warning may be displayed when an upper limit of the dependence upon one supplier previously set by a user is exceeded. After displaying a warning, the input screen shown in FIG. 4 may be displayed again to urge the user to conduct re-inputting.

In the present embodiment, the procurement risk has been described by using the dependence of an ordered part upon a specific supplier. However, the procurement risk may be evaluated by using a method other than that. For example, it becomes possible to calculate a delivery time observance rate every supplier as shown, for example, in a delivery time observance information storage unit 540, for example, by adding a scheduled delivery date and an actual delivery date to the ordering detail history information 620. Specifically, it is possible to conduct processing which will be described later at the step S005, for example, output a procurement risk information storage unit 550 at the step S005, on the basis of information in the delivery time observance information storage unit 540 and the terminal supplier risk information storage unit 360.

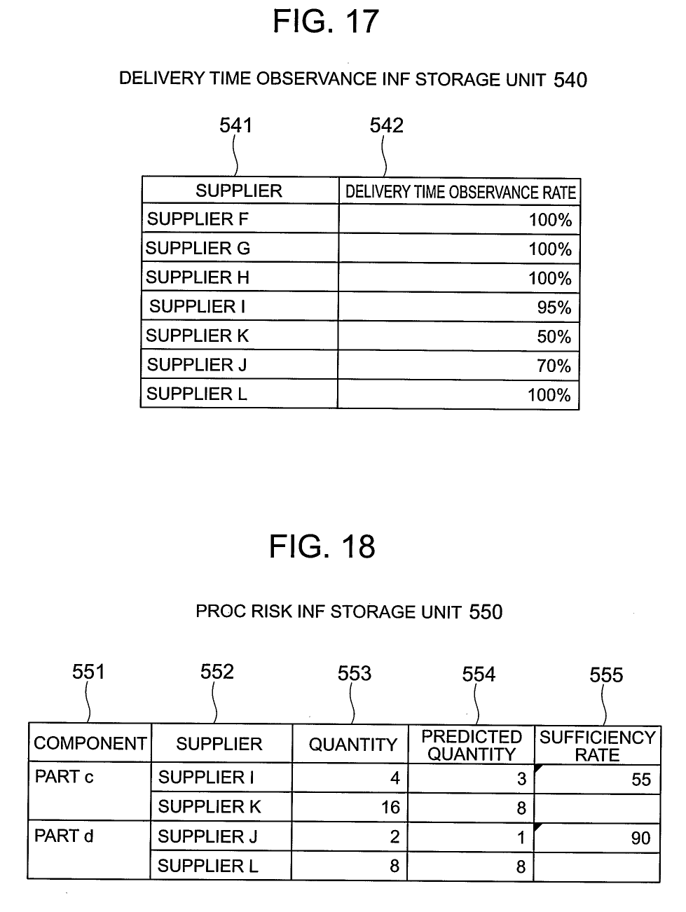

FIG. 17 is a diagram showing a configuration example of the delivery time observance information storage unit 540. The delivery time observance information storage unit 540 stores at least a supplier 541 and a delivery time observance rate 542. The supplier 541 is a column for storing a name of a supplier which supplies a part. The delivery time observance rate 542 is a column for storing information of a delivery time observance rate of the supplier. For example, according to a first record in the present table, it is appreciated that the delivery time observance rate of “supplier F” is “100%.” The delivery time observance rate in the present table may be a delivery time observance rate of a specific part for which the procurement risk evaluation is conducted, or may be a delivery time observance rate totalized for all parts handled by the supplier.

FIG. 18 is a diagram showing a configuration example of the procurement risk information storage unit 550. The procurement risk information storage unit 550 stores at least a component 551, a supplier 552, a quantity 553, a predicted quantity 554, and a sufficiency rate 555. The component 551 is a column for storing a component name of a part which becomes an object of procurement risk evaluation. The supplier 552 is a column for storing an order receiver enterprise of a component of a part which becomes an object of procurement risk evaluation. The quantity 553 is a column for storing a quantity of a component of a part which becomes an object of procurement risk evaluation ordered from each order receiver. The predicted quantity 554 is a column for storing a predicted delivery quantity. The predicted delivery quantity 554 can be found by multiplying the delivery time observance rate 542 in the delivery time observance information storage unit 540 by the quantity 553 (with a fraction below decimal point omitted). The sufficiency rate 555 is a column for storing a sufficiency rate of the predicted quantity to the order quantity. For example, according to a first record in the present table, it is appreciated that a component “part c” in quantity “4” is ordered from “supplier I” whereas the predicted quantity based on a delivery time observance rate (95%) for the supplier I in the past is “3” (4*0.95). Furthermore, considering delivery time observance rates (supplier I=0.95 and supplier K=0.5) of both “supplier I” and “supplier K,” which are suppliers of “part c,” it is appreciated that according to the prediction a quantity of 55% ((predicted value 11=3+8)÷20) in the total sum (20=4+16) of ordered quantities is supplied. It becomes possible to study, for example, a change of an order receiver enterprise of the “part c” beforehand by presenting the present table to the orderer in the output processing unit 140. This sufficiency rate may be used as indexes of procurement risk evaluation in addition to the dependence described above. In the present processing example, the delivery time observance rate is utilized as the supplier evaluation method. For example, an inspection passage rate which indicates the quality of a part to be delivered can also be calculated by using a similar method.

Owing to the processing procedure described heretofore, the orderer can evaluate the procurement risk concerning an ordered part. In other words, the orderer orders as shown in the ordering information storage unit 310 by using the input screen 400. “Part A” is ordered dispersedly from “supplier A” and “supplier B” in order to avoid a procurement risk in the primary supplier. According to the processing in the present invention, it is possible to grasp that “part a” which is one of components of the “part A” is ordered from “supplier A” and “supplier B,” and both the two corporations, “supplier A” and “supplier B” order the “part a” from only “supplier F,” and they don't order the “part a” from other suppliers. If the “supplier F” encounters a situation in which continuation of business is difficult, such as a natural disaster, a dispute, or terrorism, then supply of the “part a” from the “supplier F” stagnates and consequently there is a possibility that supply of “part A” will also stagnate eventually. On the other hand, “part B” is also ordered dispersedly from “supplier C” and “supplier D.” According to the processing in the present invention, it is appreciated that “part c” and “part d,” which are components of the “part B,” are ordered dispersedly from “supplier I” and “supplier K,” and “supplier J” and “supplier L,” respectively. Even if one of the suppliers encounters a situation such as a natural disaster, a dispute, or terrorism, it becomes possible to be supplied with the “part B” by increasing the quantity ordered from the other supplier. Business can be continued even under the situation such as a natural disaster, a dispute, or terrorism by conducting such procurement risk evaluation.

In the present embodiment, procurement risk evaluation as far as the secondary supplier has been described. However, it is also possible to implement calculation of a procurement risk concerning a supplier below a secondary supplier on the basis of the present embodiment. At that time, for example, the terminal supplier 354 in the terminal supplier totalization information storage unit 350 should be traced back to a tertiary supplier, a quartic supplier, . . . , as far as a terminal supplier.

Then, a method using share information of a part as input will now be described as an embodiment 2. In the present embodiment, an example of an apparatus and a method for evaluating procurement risks of secondary suppliers and subsequent suppliers concerning order contents accurately and quickly by using market occupation information of parts which constitute an ordered part and present the evaluated procurement risks to an orderer when the orderer conducts ordering business will be described.

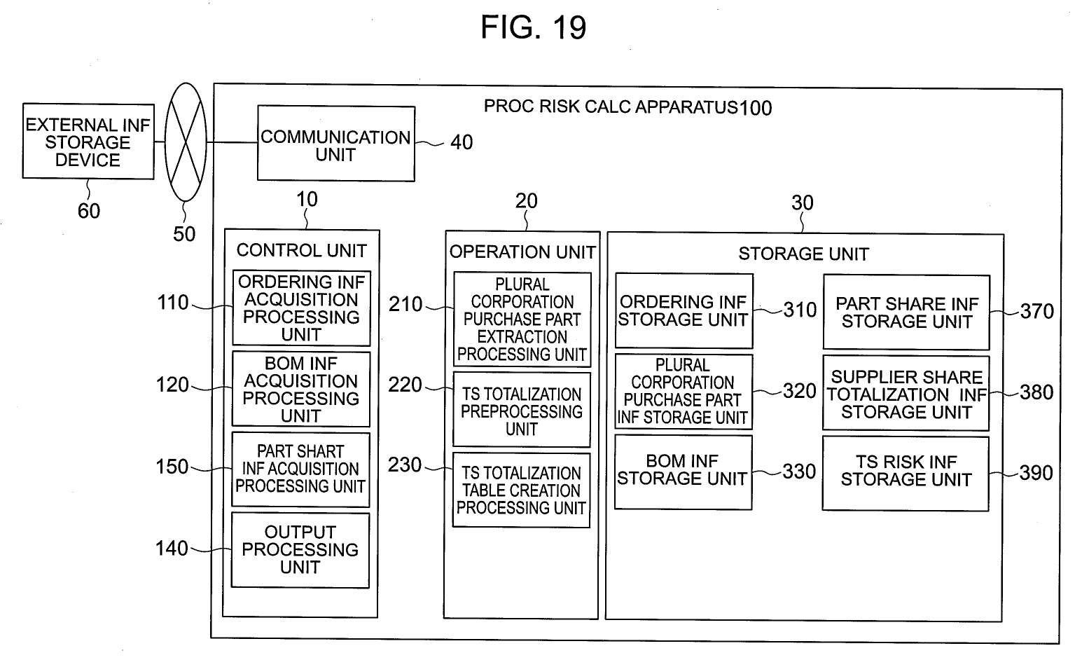

FIG. 19 is a diagram showing a configuration example of a procurement risk calculation apparatus 100 according to the second embodiment. The procurement risk calculation apparatus 100 in the present embodiment includes a control unit 10, an operation unit 20, a storage unit 30, and a communication unit 40. Information required for processing in the operation unit 20 can be acquired from an external information storage device 60 via a network 50 by using the communication unit 40 as an interface. The network 50 is typically a communication network managed by an organization of users such as a LAN (Local Area Network). However, the network 50 is not restricted to this, but the network 50 may be a communication network which partially uses a public communication network such as Internet, or a common public line such as the WAN (Wide Area Network) or VPN (Virtual Private Network). The control unit 10 receives ordering information concerning a part transmitted by an orderer, by using an ordering information acquisition processing unit 110 via the network 50, receives BOM information concerning configuration information of the part by using a BOM information acquisition processing unit 120, receives information concerning part shares by using a part share information acquisition processing unit 150, requests the operation unit 20 to conduct operation processing which will be described later, receives information concerning a result of the processing, and presents the result to the orderer via an output processing unit 140.

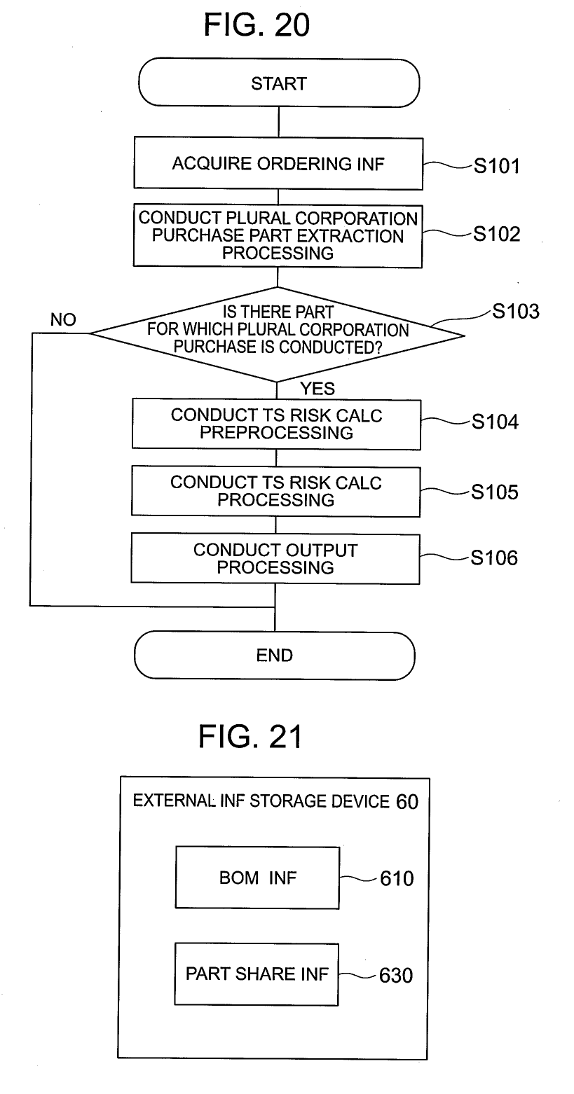

FIG. 20 is a diagram showing an example of a processing flow in the control unit 10 and the operation unit 20 in the procurement risk calculation apparatus 100. The ordering information acquisition processing unit 110 receives a request to start order (ordered part, name of order receiver enterprise, and order quantity) processing from an orderer, and the output processing unit 140 configures an input screen 400 shown in FIG. 4 and causes the output device 202 to display the screen. As a result, each processing in the operation unit 20 is started.

First, the operation unit 20 accepts an ordered part name, an order receiver enterprise name, and a quantity as ordering information generated newly by an orderer, and stores the ordered part name, the order receiver enterprise name, and the quantity into an ordering information storage unit 310 (step S101). Concrete processing contents and a configuration example of the ordering information storage unit 310 are similar to those in the embodiment 1, and consequently description of them will be omitted.

Then, the operation unit 20 extracts parts ordered from a plurality of enterprises which are at least two corporations, from ordering information accepted at the step S101 and stored in the ordering information storage unit 310 (step S102). Since concrete processing contents are similar to those in the embodiment 1, description of them will be omitted.

Then, the operation unit 20 makes a decision whether there is a part for which plural corporation purchase is conducted, on the basis of the ordering information stored in the plural corporation purchase part information storage unit 320 as a result of the processing conducted by the plural corporation purchase part extraction processing unit 210 at the step S102 (step S103). Since concrete processing contents are similar to those in the embodiment 1, description of them will be omitted.

Then, the operation unit 20 conducts preprocessing for calculating a procurement risk for a plural corporation purchase part on the basis of ordering information of plural corporation purchase stored in the plural corporation purchase part information storage unit 320, configuration information of a part stored in BOM information 610, and share information representing a market occupation rate of a part stored in part share information 630, in its terminal supplier totalization preprocessing unit 220 (step S104).

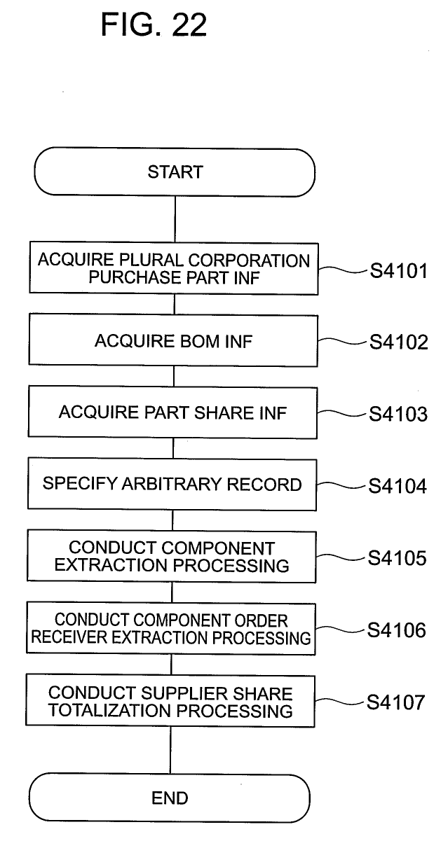

The preprocessing (the step S104) for calculating a procurement risk for a plural corporation purchase part conducted in the terminal supplier totalization preprocessing unit 220 will now be described in detail. FIG. 22 shows a flow example of preprocessing for calculating a terminal supplier risk. First, the operation unit 20 extracts all records for plural corporation purchase parts from the plural corporation purchase part information storage unit 320 (step S4101). Then, the BOM information acquisition processing unit 120 receives the BOM information 610 from the external information storage device 60, extracts only records corresponding to the parts included in the plural corporation purchase part information storage unit 320, and stores the records into a BOM information storage unit 330 in the storage unit 30 (step 4102). Since the BOM information 610 stored in the external information storage device 60 and the BOM information storage unit 330 used here are similar to those in the embodiment 1, description of them will be omitted. Then, the part share information acquisition processing unit 150 in the control unit 10 receives the part share information 630 from the external information storage device 60, extracts only records corresponding to the parts included in the plural corporation purchase part information storage unit 320, and stores the records into a part share information storage unit 370 in the storage unit 30 (step S4103).

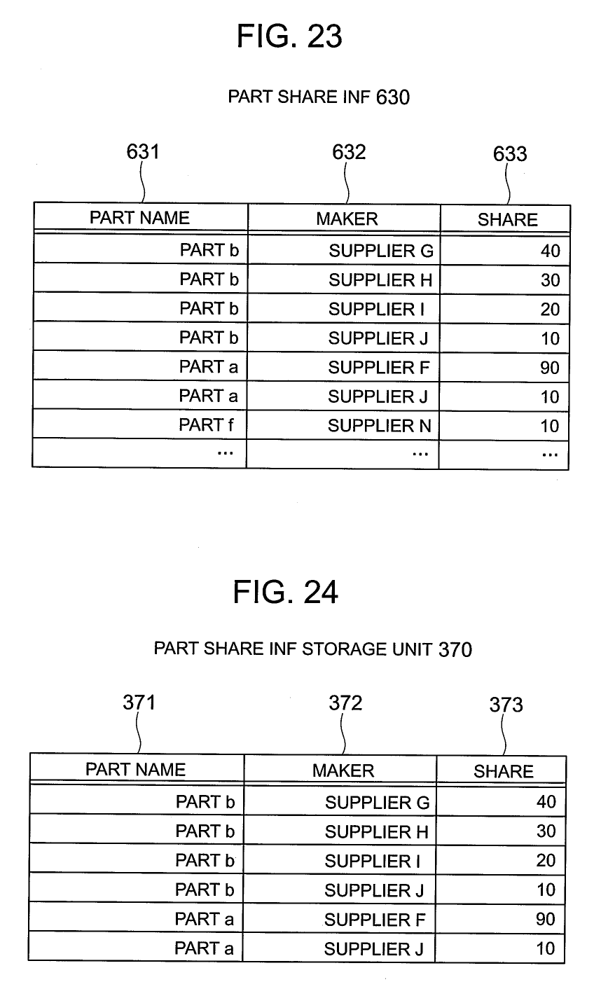

The part share information 630 and the part share information storage unit 370 will now be described. FIG. 23 is a diagram showing a configuration example of the part share information 630 stored in the external information storage device 60. The part share information 630 stores at least, a part name 631, a maker 632, and a share 633. The part name 631 is a column for storing an ordered part name. The maker 632 is a column for storing a name of a maker which manufactures the part. The share 633 is a column for storing occupation rate (share) information of the part in the market. For example, according to a first record in the present table (a second line in the table), it is appreciated that the market occupation rate of the maker “supplier G” for the part name “part b” has contents indicating a share of “40.” In other words, it is appreciated that “part b” representing the part name is stored in the part name 631, “supplier G” representing the maker name is stored in the maker 632, and “40” representing the market occupation rate is stored in the share 633. In general, this information is data which can be obtained by using a third-party organization which surveys the trend of the market or a market survey result. Such share information may be information based on the quantity supplied to the market, or may be information based on the amount sold in the market.

FIG. 24 is a diagram showing a configuration example of the part share information storage unit 370 in the storage unit 30. The part share information storage unit 370 stores at least, a part name 371, a maker 372, and a share 373. The part name 371 is a column for storing an ordered part name. The maker 372 is a column for storing a name of a maker which manufactures the part. The share 373 is a column for storing occupation rate (share) information of the part in the market. For example, according to a first record in the present table (a second line in the table), it is appreciated that the market occupation rate of the maker “supplier G” for the part name “part b” has contents indicating a share of “40.” In other words, it is appreciated that “part b” representing the part name is stored in the part name 371, “supplier G” representing the maker name is stored in the maker 372, and “40” representing the market occupation rate is stored in the share 373.

Then, one arbitrary record is extracted from the plural corporation purchase part information storage unit 320 stored in the storage unit 30 (step S4104). Then, a record coinciding with an ordered part name 321 included in the arbitrary record extracted at the step S4104 is acquired from the BOM information storage unit 330 (step S4105). Then, a record coinciding a part included in the record acquired at the step S4105 and an order receiver enterprise name included in the record in the plural corporation purchase part information storage unit 320 selected at the step S4104 is acquired from the part share information 630 stored in the storage unit 30 (step S4106). Then, an ordered part name 321 and an order receiver enterprise name 322 included in the arbitrary record in the plural corporation purchase part information storage unit 320 acquired at the step S4104, a child part name 612 acquired from the BOM information 610 at the step S4105, and the share 633 acquired from the part share information 630 are stored in a supplier share totalization information storage unit 380 in the storage unit 30 (S4107).

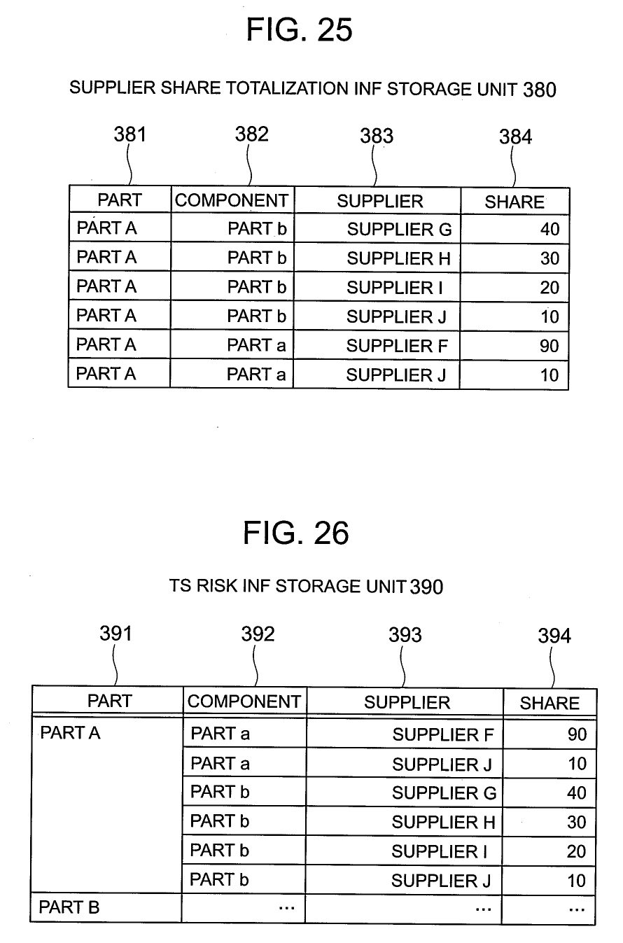

The supplier share totalization information storage unit 380 stored in the storage unit 30 will now be described. FIG. 25 is a diagram showing a configuration example of the supplier share totalization information storage unit 380 stored in the storage unit 30. The supplier share totalization information storage unit 380 stores at least a part 381, a component 382, a supplier 383 and a share 384. The part 381 is a column for storing a name of an ordered part. The component 382 is a column for storing a child part name which constitutes the part. The supplier 383 is a column for storing a name of an enterprise which supplies the component. The share 384 is a column for storing occupation rate (share) information of the part in the market. For example, according to a first record in the present table (a second line in the table), it is appreciated that the market occupation rate of the “supplier G” supplying the “part b” which is a component of the part “part A” has contents indicating a share of “40.” In other words, it is appreciated that “part A” representing the part name is stored in the part 381, “part b” representing the component is stored in the component 382, “supplier G” representing the supplying maker name is stored in the maker 382, and “40” representing the market occupation rate is stored in the share 383.

Specifically, all records in the plural corporation purchase part information storage unit 320 stored in the storage unit 30 are extracted and retained on the memory at the step S4101. Then, at the step S4102, the BOM information acquisition processing unit 120 extracts only records coinciding with the ordered part name 321 included in the plural corporation purchase part information storage unit 320 from the BOM information 610 stored in the external information storage device 60 as shown in FIG. 21, and stores the records into the BOM information storage unit 330 in the storage unit 30. In the case of the present example, records concerning “part A” and “part B” are stored in the ordered part name 321 column in the plural corporation purchase part information storage unit 320. Therefore, the BOM information acquisition processing unit 120 extracts only records concerning “part A” and “part B” from the BOM information 610 and stores the records into the BOM information storage unit 330. Then, at the step S4103, the part share information acquisition processing unit 150 extracts records which include, in the ordered part name 621 column, part names included in the parent part 331 and the child part 332 in the BOM information storage unit 330, from the part share information 630 stored in the external information storage device 60 as shown in FIG. 21, and stores the records into the part share information storage unit 370. In the case of the present example, “part A,” “part B,” “part a,” “part b,” “part c” and “part d” are included in the parent part 331 and the child part 332 in the BOM information storage unit 330. Records including any of these part names in the part name 631 column are extracted and stored into the part share information storage unit 370. Then, at the step S4104, an arbitrary record is extracted out of records stored in the plural corporation purchase part information storage unit 320. In the present example, the first record (part A, supplier A, and 10) is acquired. Then, at the step S4105, the parent part name 611 in the BOM information 610 is searched by using the “part A” stored in the ordered part name 321 in the record acquired at the step S4104 as a key. In the case of the present example, the BOM information 610 is searched for the “part A.” As a result, a first record (part A and part a) in the BOM information 610 is extracted. At the step S4106, the part name 631 in the part share information acquisition processing unit 150 is searched by using the “supplier A” stored in the order receiver enterprise name 322 in the record acquired at the step S4104 and the child part name 612 “part b” acquired at the step S4105 as a key. In the case of the present example, a search is made by using the “part b” as a key. As a result, a first record (part b, supplier G, and 40) in the part share information 630 is extracted. Then, at the step S4107, data (part b, supplier G, and 40) extracted and retained at the step S4105 and the step S4106 are stored into the part share information storage unit 370. Returning to the step S4105, similar processing is also conducted for “part a” which is a component of the part A. Upon finishing similar processing for all components of the part A, the processing returns to the step S4104 and processing concerning “supplier B” of “part A” is conducted in the same way. Such processing is repeated. Details of the processing at the step S104 has been described heretofore.

Then, the operation unit 20 receives the supplier share totalization information storage unit 380 which is the processing result at the step S104, and conducts processing in a supplier risk calculation processing unit 250 (step S105). Specifically, totalization every part is conducted on the data stored in the supplier share totalization information storage unit 380, and its result is stored into a terminal supplier risk information storage unit 390 in the storage unit 30. The procurement risk in the present embodiment is obtained by calculating the degree of concentration of terminal suppliers supplying parts which constitute a part ordered by the ordering enterprise. For calculating the procurement risk, therefore, it is necessary to calculate a ratio at which each of components of an ordered part is supplied by each of secondary and subsequent suppliers. Therefore, the terminal supplier risk information storage unit 390 stores a result of totalizing a ratio at which each of components is supplied by each of secondary suppliers every ordered part.

FIG. 26 is a diagram showing a configuration example of the terminal supplier risk information storage unit 390. The terminal supplier risk information storage unit 390 stores at least a part 391, a component 392, a supplier 393, and a share 394. The part 391 is a column for storing a part name which becomes an object of procurement risk evaluation. The component 392 is a column for storing a component name of the part which becomes the object of procurement risk evaluation. The supplier 393 is a column for storing an order receiver enterprise of a part constituting the part which becomes the object of procurement risk evaluation. The share 394 is a column for storing share information of a part constituting the part which becomes the object of procurement risk evaluation. For example, according to the present table, a share of “supplier F” for the “part a” which is a component of “part A” is “90.”

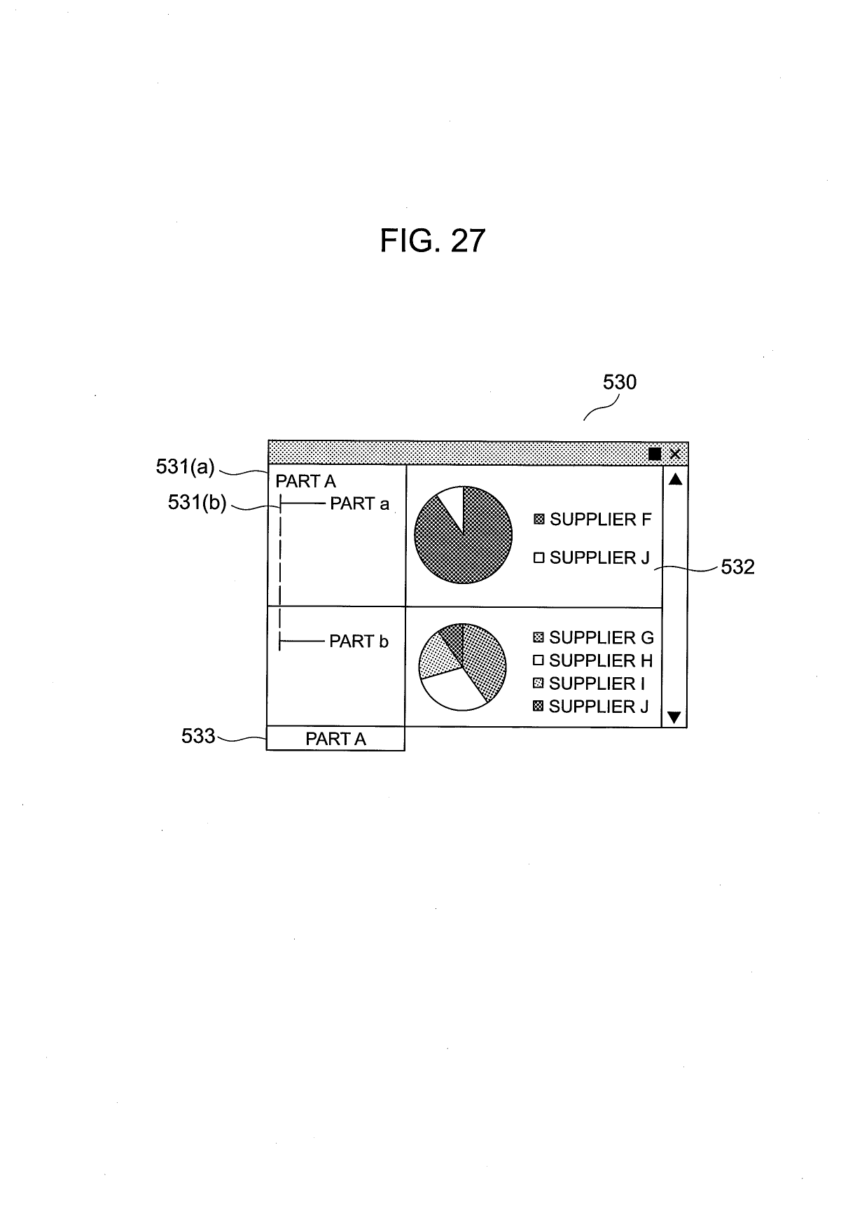

Then, the operation unit 20 receives information stored in the terminal supplier risk information storage unit 390, which is the processing result at the step S105, and conducts output processing in the output processing unit 140 in the control unit 10 (step S106). Specifically, the operation unit 20 receives information in the terminal supplier risk information storage unit 390, and the output processing unit 140 constitutes an output screen 530 shown in FIG. 27, and causes the output device 202 to display the screen.

FIG. 27 is a diagram showing a configuration example of the output screen 530. The output screen 530 includes a tree display unit 531, a graph display unit 532, and a display changeover tab button 533. The tree display unit 531 is an area for displaying a parent-child configuration of a part which becomes an object of procurement risk evaluation, in a tree form. In the tree display unit 531, the relation between the part 391 and the component 392 can be displayed in a tree form. Specifically, “part A” stored in the part 391 is displayed in 531(a) in the tree display unit 531, and “part a” and “part b” stored in the component 392 are displayed in 531(b) in the tree display unit 531. The graph display unit 532 can conduct graph display of the share information in the terminal supplier risk information storage unit 390 corresponding to 531(b) in the tree display unit 531. Specifically, the share 394 of the supplier stored in the supplier 393 is displayed in the graph display unit 532 by using, for example, a circle graph. The display changeover tab button 533 is a button for executing changeover of an object part of procurement risk evaluation. Specifically, if the display changeover tab button 533 is selected, a transition to a diagram showing a procurement risk evaluation result concerning “part B” is made.

Owing to the processing procedure described heretofore, the orderer can evaluate the procurement risk concerning an ordered part. In other words, the orderer orders as shown in the ordering information storage unit 310 by using the input screen 400. “Part A” is ordered dispersedly from “supplier A” and “supplier B” in order to avoid a procurement risk in the primary supplier. As appreciated according to the processing in the present invention, there is a possibility that “part a” which is one of components of the “part A” is supplied from “supplier F” or “supplier J.” And the share occupied by the “supplier F” in all supplied quantities of the “part a” is 90%, and it can be said that most thereof depends upon the “supplier F.” If the “supplier F” encounters a natural disaster, a dispute, or terrorism, then supply of the “part a” from the “supplier F” stagnates and consequently supply of “part A” will also stagnate eventually.

In the present embodiment, procurement risk evaluation as far as the secondary supplier has been described. However, it is also possible to implement calculation of a procurement risk concerning a supplier below a secondary supplier on the basis of the present embodiment. At that time, for example, the terminal supplier 354 in the terminal supplier totalization information storage unit 350 should be traced back to a tertiary supplier, a quartic supplier, . . . , as far as a terminal supplier.

In the embodiment 1 and the embodiment 2, use for evaluating the procurement risk beforehand at the time of ordering has been described. If for example, a disaster or terrorism has occurred on a supply chain, influence upon transaction contents of an ordering enterprise can be presented quickly by applying the present invention to contents already ordered. Such utilization is also possible.

By the way, the present invention is not restricted to the above-described embodiments, but various modifications are included. For example, the embodiments have been described in detail to make the present invention intelligible. It is not always necessary to have all described configurations. Furthermore, it is possible to replace a part of the configuration in one embodiment with a part of the configuration in the other embodiment. Furthermore, it is also possible to add a configuration in one embodiment to a configuration in the other embodiment. Furthermore, as to a part of the configuration in each embodiment, it is possible to conduct addition, removal, or replacement of another configuration.

Furthermore, a part or all of the above-described configurations, functions, processing units, and processing means may be implemented with hardware by designing, for example, an integrated circuit. Furthermore, the above-described configurations and functions may be implemented with software by causing a processor to interpret and execute programs for implementing respective functions. Information such as a program, a table, or a file which implements each function can be stored in a recording device such as a memory, a hard disk, or an SSD (Solid State Drive), or a recording medium such as an IC card, an SD card, or a DVD.

As for control lines and information lines, those considered to be necessary for description are shown, and all control lines and information lines on the product are not always shown. It may be considered that almost all configurations are connected to each other as a matter of fact.

It should be further understood by those skilled in the art that although the foregoing description has been made on embodiments of the invention, the invention is not limited thereto and various changes and modifications may be made without departing from the spirit of the invention and the scope of the appended claims.

1. A procurement risk calculation method to be used in a calculation apparatus comprising at least a storage unit and an operation unit, the procurement risk calculation method comprising the steps of:
inputting ordering information, the ordering information comprising a part to be ordered, an order receiver, and a quantity of the part to be ordered;
acquiring part table information which represents relations between a parent part and child parts;
acquiring past ordering detail history information which represents an ordering enterprise and an order receiver enterprise for an ordered part name;
identifying a parent part for which plural corporation purchase is conducted, by using the ordering information, the part table information, and the ordering detail history information, and generating terminal supplier risk information indicating child parts constituting the parent part, suppliers which supply the child parts, and ependence of the parent part upon each of the suppliers; and
displaying suppliers which supply the child parts and the dependence of the parent part upon each of the suppliers to a user.

2. The procurement risk calculation method according to claim 1, wherein the dependence is a ratio of a quantity ordered from a specific supplier to a required quantity of a child part.

3. The procurement risk calculation method according to claim 1, further comprising the steps of:
acquiring delivery time observance information which represents a delivery time observance rate every supplier; and
calculating, for the child part, a sufficiency rate of a part supplied from suppliers by multiplying quantities supplied from suppliers by the delivery time observance rates.

4. A procurement risk calculation method to be used in a calculation apparatus comprising at least a storage unit and an operation unit, the procurement risk calculation method comprising the steps of:
inputting ordering information, the ordering information comprising a part to be ordered, an order receiver, and a quantity of the part to be ordered;
acquiring part table information which represents relations between a parent part and child parts;
acquiring market share information of suppliers of the child parts;
identifying a parent part for which plural corporation purchase is conducted, by using the ordering information, the part table information, and the market share information, and generating terminal supplier risk information indicating child parts constituting the parent part, suppliers which supply the child parts, and shares of the suppliers for the parent part; and
displaying suppliers which supply the child parts and shares of the suppliers, for the parent part to a user.

5. The procurement risk calculation method according to claim 1, wherein at the step of displaying suppliers and shares to a user, the relations between a parent part and child parts are displayed on a tree, and distribution of suppliers is displayed by a graph for each of the child parts.

6. A procurement risk calculation apparatus comprising at least a storage unit, an operation unit and an output processing unit,
the storage unit storing ordering information which includes a part to be ordered, an order receiver, and a quantity of the part to be ordered and which is input, part table information which represents relations between a parent part and child parts, and past ordering detail history information which represents an ordering enterprise and an order receiver enterprise for an ordered part name;
the operation unit identifies a parent part for which plural corporation purchase is conducted, by using the ordering information, the part table information, and the ordering detail history information, and generates terminal supplier risk information indicating child parts constituting the parent part, suppliers which supply the child parts, and dependence of the parent part upon each of the suppliers, and
the output processing unit outputs suppliers which supply the child parts and the dependence of the parent part upon each of the suppliers.

7. The procurement risk calculation apparatus according to claim 6, wherein the dependence is a ratio of a quantity ordered from a specific supplier to a required quantity of a child part.

8. The procurement risk calculation apparatus according to claim 6, wherein
the storage unit stores delivery time observance information which represents a delivery time observance rate every supplier, and
the operation unit calculates, for the child part, a sufficiency rate of a part supplied from suppliers by multiplying quantities supplied from suppliers by the delivery time observance rates.

9. A procurement risk calculation apparatus comprising at least a storage unit, an operation unit, and an output processing unit,
the storage unit storing ordering information which includes a part to be ordered, an order receiver, and a quantity of the part to be ordered and which is input, part table information which represents relations between a parent part and child parts, and market share information of suppliers of the child parts,
the operation unit identifies a parent part for which plural corporation purchase is conducted, by using the ordering information, the part table information, and the market share information, and generates terminal supplier risk information indicating child parts constituting the parent part, suppliers which supply the child parts, and market shares of the suppliers for the parent part, and
the output processing unit outputs suppliers which supply the child parts and market shares of the suppliers, for the parent part.

10. The procurement risk calculation apparatus according to claim 6, wherein the output processing unit outputs a display screen which displays the relations between a parent part and child parts on a tree and displays distribution of suppliers by a graph for each of the child parts.

11. Non-transitory computer storage media storing computer-executable instructions causing a calculation apparatus to implement the steps for calculating a procurement risk, the calculation apparatus comprising at least a storage unit and an operation unit, the steps including:
inputting ordering information, the ordering information comprising a part to be ordered, an order receiver, and a quantity of the part to be ordered;
acquiring part table information which represents relations between a parent part and child parts;
acquiring past ordering detail history information which represents an ordering enterprise and an order receiver enterprise for an ordered part name;
identifying a parent part for which plural corporation purchase is conducted, by using the ordering information, the part table information, and the ordering detail history information, and generating terminal supplier risk information indicating child parts constituting the parent part, suppliers which supply the child parts, and dependence of the parent part upon each of the suppliers; and
displaying suppliers which supply the child parts and the dependence of the parent part upon each of the suppliers to a user.

12. The non-transitory computer storage media according to claim 11, wherein the dependence is a ratio of a quantity ordered from a specific supplier to a required quantity of a child part.

13. The non-transitory computer storage media according to claim 11, further executing the procedures for:
acquiring delivery time observance information which represents a delivery time observance rate every supplier; and
calculating, for the child part, a sufficiency rate of a part supplied from suppliers by multiplying quantities supplied from suppliers by the delivery time observance rates.

14. Non-transitory computer storage media storing computer-executable instructions causing a calculation apparatus to implement the steps for calculating a procurement risk, the calculation apparatus comprising at least a storage unit and an operation unit, the steps including:
inputting ordering information, the ordering information comprising a part to be ordered, an order receiver, and a quantity of the part to be ordered;
acquiring part table information which represents relations between a parent part and child parts;
acquiring market share information of suppliers of the child parts;
identifying a parent part for which plural corporation purchase is conducted, by using the ordering information, the part table information, and the market share information, and generating terminal supplier risk information indicating child parts constituting the parent part, suppliers which supply the child parts, and shares of the suppliers for the parent part; and
displaying suppliers which supply the child parts and shares of the suppliers, for the parent part to a user.

15. The non-transitory computer storage media according to claim 11, wherein in the procedure for displaying suppliers and shares to a user, the relations between a parent part and child parts are displayed on a tree, and distribution of suppliers is displayed by a graph for each of the child parts.
